(19) United States
(12) Patent Application Publication
(10) Pub. No.: US 2025/0158366 A1
(43) Pub. Date: May 15, 2025

(54) TWO PIECE BARRIER CABLE GLAND

(71) Applicant: EATON INTELLIGENT POWER LIMITED, DUBLIN (IE)

(72) Inventor: Himanshu Khokle, Nagpur (IN)

(21) Appl. No.: 18/937,858

(22) Filed: Nov. 5, 2024

(30) Foreign Application Priority Data
Nov. 10, 2023 (IN) 202311076985

(51) Int. Cl. H02G 3/06; H02G 15/013

(52) U.S. Cl. CPC H02G 3/0675; H02G 3/0641; H02G 15/013

(57) ABSTRACT

A cable gland assembly includes a hub body defining an internal passage. The cable gland assembly further includes an intermediate body defining an internal passage, wherein the hub body receives the intermediate body, the intermediate body having a first end and a second end opposite the first end, wherein the second end of the intermediate body includes a threaded engagement portion. A gland nut having a first end and an opposite second end, the first end of the gland nut snap-fits to the threaded engagement portion of the intermediate body to secure a cable in the cable gland. A union nut having a first end and a second end, the first end of the union nut is threadedly coupled to the second end of the hub body, the second end of the union nut having a shoulder.

### FIELD OF INVENTION

The present disclosure relates generally to a cable gland. More particularly, the present disclosure relates to a cable gland having a gland nut that is configured to couple to a hub body.

### BACKGROUND

Cable glands are used for terminating cables in hazardous and nonhazardous environments. More specifically, cable glands generally provide a means for terminating cables, such as unarmored cables (e.g., TC-type) and armored cables, at junction boxes, control centers, panelboards, enclosures, structures, and the like. Known cable glands are used to seal the junction between a cable and a device or a structure into which the cable is extending.

Additionally, existing cable gland assemblies may be assembled from several components. At various times, the cable assembly may need to be disassembled or reassembled, particularly for inspection purposes or for checking condition of sealant (barrier compound). During disassembly, the numerous components of a conventional cable gland may come apart, including those that do not need to separate for purposes of the disassembly. This makes disassembly and reassembly of the cable gland assembly more complex, time consuming, and error prone. Furthermore, environmental debris may enter the cable gland from mating points of certain components as conventional cable gland assemblies may not provide a robust enough seal between certain components. This may lead to degradation of the cable or conductor and reduce the quality of the cable gland.

### SUMMARY OF THE INVENTION

In one embodiment, a cable gland assembly includes a hub body having a first end configured to threadedly couple to a structure and a second end opposite the first end, wherein an exterior portion of the second end of the hub body is threaded, the hub body defining an internal passage. The cable gland assembly further includes an intermediate body with an integrated compound chamber defining an internal passage, wherein the hub body receives the intermediate body, the intermediate body having a first end and a second end opposite the first end, wherein the second end of the intermediate body includes a threaded engagement portion that extends outward past the second end of the hub body. The cable gland assembly further includes a gland nut having a first end and an opposite second end, the first end of the gland nut snap-fits to the threaded engagement portion of the intermediate body to secure a cable in the cable gland, the gland nut defining an internal passage such that the internal passage of the gland nut is in fluid communication with the internal passage of the intermediate body. The cable gland assembly further includes a union nut having a first end and a second end opposite the first end, the first end of the union nut is threadedly coupled to the second end of the hub body, the second end of the union nut having a shoulder, the union nut defining an internal passage such that the internal passage of the union nut is in fluid communication with the internal passage of the gland nut and the internal passage of the intermediate body, wherein the gland nut fits within the internal passage of the union nut.

In another embodiment, a cable gland assembly includes a hub body configured to receive at least a portion of a cable. The cable gland assembly further includes an intermediate body configured to receive at least a portion of the cable, the intermediate body having a first portion of the intermediate body that is disposed within the hub body and a second portion of the intermediate body that extends outside of the hub body, the second portion having a threaded external wall. The cable gland assembly further includes a gland nut configured to receive at least a portion of the cable, the gland nut having a first end and a second end, the first end having a plurality of elongated openings extending axially from the first end of the gland nut, wherein the openings define a plurality of circumferentially spaced fingers, the fingers having threaded internal walls that engage the threaded external wall of the second portion of the intermediate body, and the second end having a shoulder. The cable gland assembly even further includes a union nut configured to receive at least a portion of the cable, the union nut having a first end and a second end, the first end receives the gland nut and threadedly couples the union nut to the hub body, the second end having a shoulder, the union nut shoulder applies an axial force to the gland nut as the union nut is torqued onto the hub body, wherein the axial force pushes the gland nut toward the intermediate body such that the gland nut engages the threaded external wall of the second portion of the intermediate body.

In yet another embodiment, a method of installing a cable gland assembly includes providing the cable gland assembly. The cable gland assembly includes a hub body having a first end configured to threadedly couple to a structure and a second end opposite the first end, wherein an exterior portion of the second end of the hub body is threaded, the hub body defining an internal passage. The cable gland assembly further includes an intermediate body defining an internal passage, wherein the hub body receives the intermediate body, the intermediate body having a first end and a second end opposite the first end, wherein the second end of the intermediate body includes a threaded engagement portion that extends outward past the second end of the hub body. The cable gland assembly includes, a gland nut having a first end and an opposite second end, the first end of the gland nut snap-fits to the threaded engagement portion of the intermediate body to secure a cable in the cable gland, the gland nut defining an internal passage such that the internal passage of the gland nut is in fluid communication with the internal passage of the intermediate body. The cable gland assembly further includes a union nut having a first end and a second end opposite the first end, the first end of the union nut is threadedly coupled to the second end of the hub body, the second end of the union nut having a shoulder, the union nut defining an internal passage such that the internal passage of the union nut is in fluid communication with the internal passage of the gland nut and the internal passage of the intermediate body, wherein the gland nut is configured to fit within the internal passage of the union nut. The method of installing the cable gland assembly further includes passing the cable through the internal passages of the hub body, intermediate body, gland nut, and union nut. The method of installing the cable gland assembly further includes coupling the hub body to the structure. The method of installing the cable gland assembly further includes inserting the intermediate body in the internal passage of the hub body. The method of installing the cable gland assembly further includes inserting the gland nut in the internal passage of the union nut such that the gland nut shoulder abuts the union nut shoulder. The method of installing the cable gland assembly further includes torquing the union nut to threadedly couple the union nut to the hub body, thereby pushing the gland nut to snap-fit to the threads of the engagement portion of the intermediate body to secure the cable in the cable gland. The method of installing the cable gland assembly further includes untorquing the union nut from the hub body. The method of installing the cable gland assembly further includes removing the snap-fit engaged intermediate body and gland nut from the hub body, wherein the cable is secured within the intermediate body and the gland nut without the union nut. The method of installing the cable gland assembly further includes applying a sealant in the internal passage of the intermediate body at the first end of the intermediate body. The method of installing the cable gland assembly further includes allowing the sealant to cure. The method of installing the cable gland assembly further includes reinserting the snap-fit engaged intermediate body and gland nut into the internal passage of the hub body. The method of installing the cable gland assembly even further includes torquing the union nut to threadedly couple the union nut to the hub body to secure the snap-fit engaged intermediate body and gland nut in the internal passage of the hub body.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale, and the proportion of certain elements may be exaggerated for the purpose of illustration.

FIG. 1 is a side view of a prior art cable gland assembly,

FIG. 2 is a cross sectional view of one embodiment of a cable gland assembly,

FIG. 3 is a perspective view of an intermediate body of the cable gland assembly of FIG. 2,

FIG. 4 is a perspective view of a gland nut of the cable gland assembly of FIG. 2,

FIG. 5 is a cross sectional view of the cable gland assembly of FIG. 2 including a compound sealant and cable disposed therein, and

FIG. 6 is a cross sectional view of an alternative embodiment of a cable gland assembly.

### DETAILED DESCRIPTION

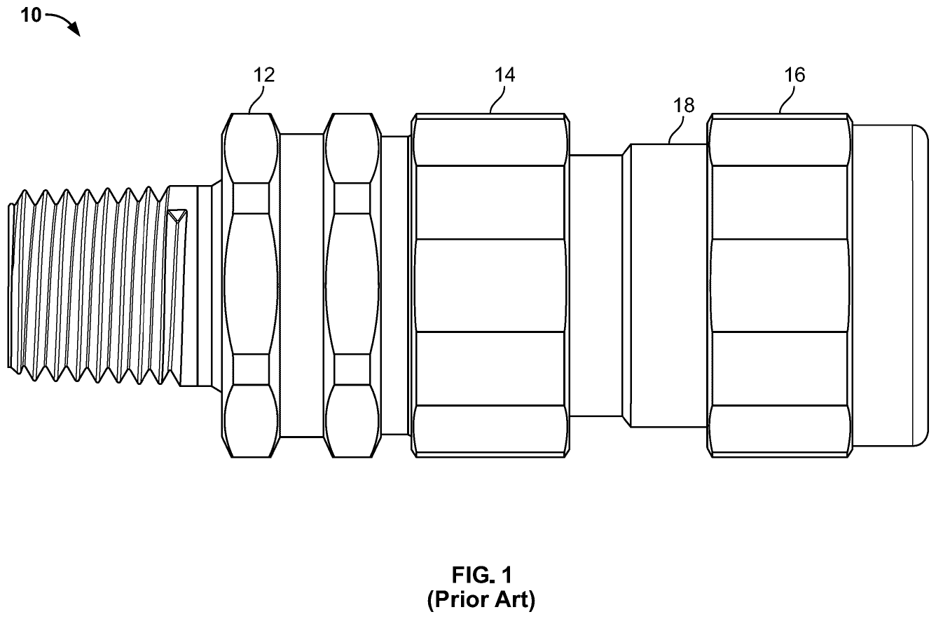

Referring to FIG. 1, prior cable glands 10 include a hub body 12 for threadedly engaging with a structure, a union nut 14 that threadedly engages the hub body 12, and a gland nut 16 that threadedly engages the intermediate body 18. Therefore, in such configurations securing a cable within the cable gland 10 would require an installer to torque three different components. Additionally, prior cable glands may need to be disassembled or reassembled. During disassembly, the numerous components of a conventional cable gland may come apart, including those that do not need to separate for purposes of the disassembly. This makes disassembly and reassembly of the cable gland assembly more complex, time consuming, and error prone. Additionally, environmental debris may enter the cable gland from mating points of certain components as conventional cable gland may not provide a robust enough seal between certain components. This may lead to degradation of the cable and reduce the quality of the cable gland. One instance where a prior cable gland may need to be disassembled is to apply a sealant in the hub body. Applying the sealant requires the union nut and gland nut to be disassembled to access the internal passage of the hub body. This process is time consuming and if the fittings are not replaced properly, it can lead to system failures. The present disclosure overcomes these deficiencies and other deficiencies in the prior art.

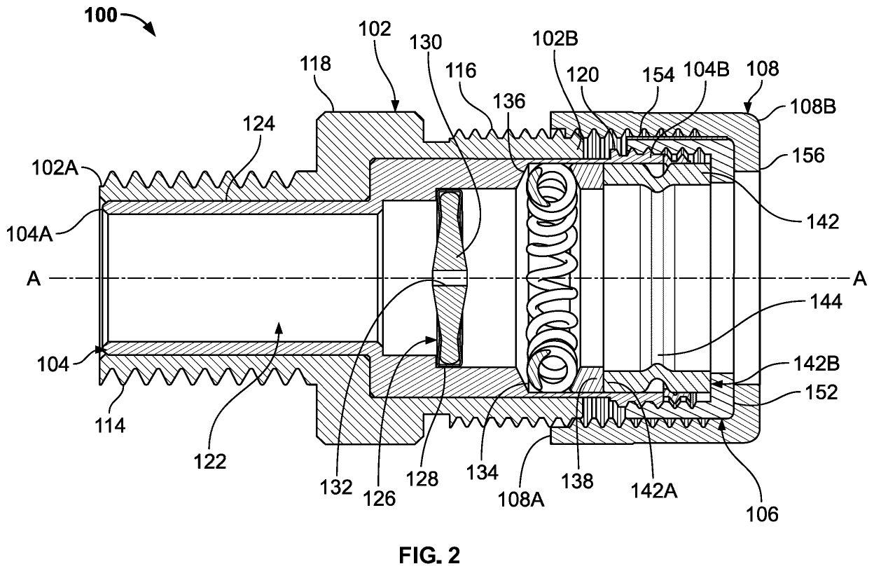

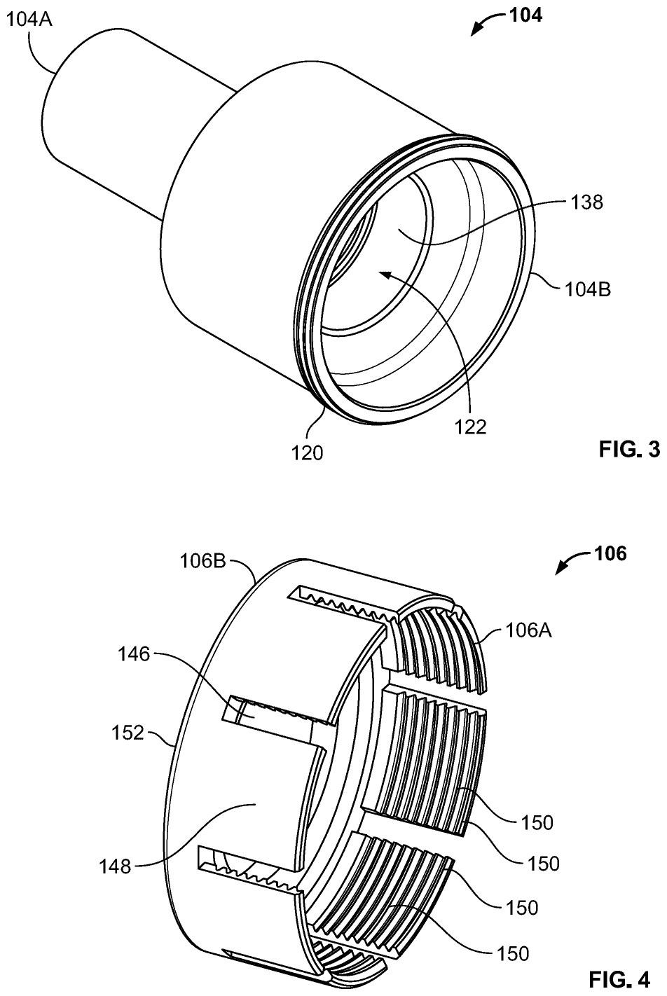

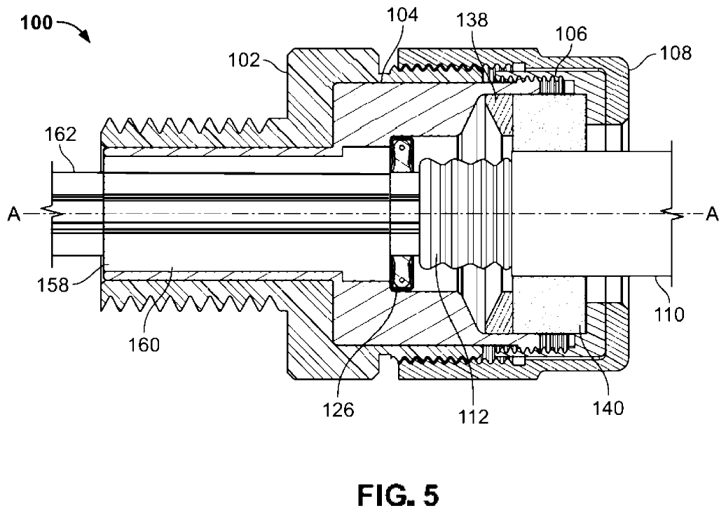

An exemplary embodiment of a cable gland assembly 100 is depicted in FIGS. 2-5. In general, the cable gland assembly 100 is configured to seal the junction between a cable 110 and a device or a structure into which the cable is extending. As explained in more detail below, the cable gland assembly 100 includes a gland nut 106 that is configured to engage an intermediate body 104 by deforming around a threaded portion 120 of the intermediate body 104. The other components of the cable gland assembly 100, also described below, are illustrative and may be of other designs or constructions.

The cable gland assembly 100 includes a hub body 102, an intermediate body 104, a gland nut 106, and a union nut 108, wherein the cable gland assembly 100 is configured to secure a portion of a cable 110 therein. The cable 110 may further include cable armor 112 disposed around the cable 110. The hub body 102 has a first end 102A with external connection threads 114 for threading into a device, an enclosure, or other structure. The hub body 102 further includes a second end 102B having external threads 116 along a portion of the second end for threadedly mating with the union nut 108. The hub body 102 further includes an internal passage that extends through the first end 102A and the second end 102B of the hub body 102. The hub body 102 may be formed from a metal, such as aluminum, stainless steel, or brass. The hub body 102 may further include a tool coupling portion 118 (e.g., a hexagonal or other polygonal structure) to aid in torquing the hub body 102 onto the structure.

The hub body 102 receives the intermediate body 104 in the internal passage of the hub body 102. The intermediate body 104 has a first end 104A, and a second end 104B opposite of the first end 104A. The first end 104A of the intermediate body 104 is disposed within the internal passage of the hub body 102. The second end 104B of the intermediate body 104 extends axially outwards past the second end 102B of the hub body 102. The second end 104B of the intermediate body 104 further includes a threaded engagement portion 120. The threaded engagement portion 120 is comprised of external threads. The intermediate body 104 further includes an internal passage 122 that extends through the first and second end 104A, 104B of the intermediate body 104. The intermediate body may be formed from a metal, such as aluminum, stainless steel, or brass. The cable gland assembly 100 may further include a flamepath 124 that is disposed between the interior surface of the hub body 102 and the exterior surface of the intermediate body 104 that is disposed within the hub body 102. The flamepath 124 is a thin passage disposed between the interior surface of the hub body 102 and the exterior surface of the intermediate body 104. The flamepath 124 is configured to permit hot or volatile gasses or vapor that are contained within the structure to slowly dissipate from the structure. The flamepath 124 alleviates buildup of gasses within the structure which if not alleviated could lead to catastrophic failure of the system. Furthermore, the flamepath 124 may be configured such that it allows the hot gasses dissipating therethrough to cool as the gasses travel through the flamepath 124 and out of the cable gland assembly 100.

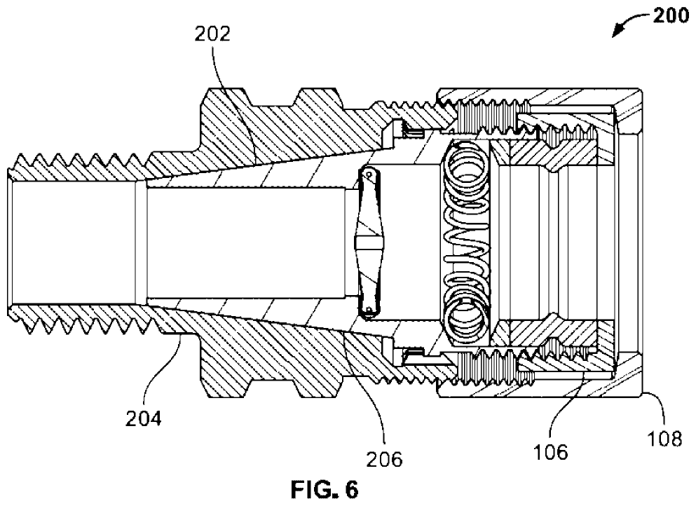

As depicted in FIG. 2, the flamepath may be a step-cylindrical flamepath 124 that follows the corresponding step transition geometries of the interior surface of the hub body 102 and the exterior surface of the intermediate body 104. In alternate embodiments, a cable gland assembly 200 may include a conical flamepath 202. As depicted in FIG. 6, the conical flamepath follows the corresponding conical transition geometries of the interior surface of the hub body 204 and the exterior surface of the intermediate body 206.

In the illustrated embodiment, the intermediate body 104 further includes a brush dam 126 disposed within the internal passage of the intermediate body 104. The brush dam 126 includes an annular filament holder 128 and a plurality of individual filaments 130 that extend radially inward from the annular filament holder 128 to define an average inner radial extent that is less than the radius defined by the annular filament holder 128. The free ends of the of the filament define a longitudinal opening 132 extending through the brush dam 126. The filaments 130 may be formed form any suitable material such as but not limited to plastic, nylon, polypropylene, polystyrene. Tampico, horsehair, metal wire, etc. The filaments 130 are generally flexible or resiliently deflectable along the length of the filaments 130. In the illustrated embodiment, the brush dam 126 is depicted axially rearward of the step transition geometry of the intermediate body 104, however in alternate embodiments, the brush dam 104 may be disposed axially forward of the step transition geometry.

The brush dam 126 is configured to permit the cable 110 to pass through the opening 132 while creating a barrier between the first end 104A and second end 104B of the intermediate body 104 to inhibit the flow of a curable sealing compound 158 that is disposed within a compound chamber 160 of the intermediate body 104. Suitable examples of sealing compounds 158 include, but are not limited to, epoxy fillers and Chico® sealing compounds commercially available from Eaton Corporation PLC. The compound chamber 160 is disposed within the internal passage 122 of the intermediate body 104. In the illustrated embodiment of FIG. 5, the compound chamber 160 is positioned axially forward of the brush dam 126. When cured, the sealing compound 158 serves as a sealant within the cable gland assembly 100 that restricts passage of gases, vapor, or flames into and through the cable gland assembly 100.

The cable gland assembly 100 may further include a garter spring 134 disposed within the internal passage 122 of the intermediate body 104 wherein the garter spring 134 is positioned axially rearward of the brush dam 126. The garter spring 134 is positioned in the intermediate body 104 such that a portion of the garter spring 134 rests on an inner surface step geometry 136 of the internal passage 122 of the intermediate body 104. The garter spring 134 is an annular grounding spring such that as the garter spring 134 is compressed against the inner surface step geometry 136, the garter spring 134 engages and surrounds the cable armor 112 to create a grounding connection. Additionally, the garter spring 134 may be configured to act as an armor stop which limits the insertion of the cable armor 112 of the cable 110 in the cable gland assembly 100 by stripping the cable armor 112 back to expose the internal cable 162. The garter spring 134 may be formed from metal, such as stainless steel with copper flash coating.

The cable gland assembly 100 may further include a washer 138 disposed axially rearward of the garter spring 134 and a bushing 140 that is disposed axially rearward of the washer 138 such that the washer 138 is disposed between the garter spring 134 and the bushing 140. The washer 138 distributes the load applied by the bushing 140 and gland nut 106 when the cable gland assembly 100 is assembled. The washer 138 may be formed from plastic, such as a polyamide. The bushing 140 is positioned in the intermediate body 104 such that a portion of the bushing 140 extends outward from the second end 104B of the intermediate body 104 whereby the portion of the bushing 140 that extends outward is disposed within the gland nut 106.

The bushing 140 may include a bushing body 142 having a generally annular shape with an interior surface defining a bushing opening 146 extending through first and second ends of the bushing body. A circumferential rib 144 is disposed on the interior surface of the bushing body. The circumferential rib 144 extends around the axis-A and extends radially inward from the interior surface toward the axis-A. In the illustrated embodiment, the circumferential rib 144 is a continuous annulus extending along the interior surface. The circumferential rib 144 may be disposed in a midplane extending through the bushing body 142 transverse to the axis-A at a location generally midway between the first and second ends of the bushing body 142. The circumferential rib 144 may be disposed at other locations along the axis-A of the bushing body 142. The rib 144 has a suitable cross-sectional shape for engaging and scaling around the cable 110 received in the cable gland assembly 100.

The gland nut 106 includes a first end 106A, and a second end 106B opposite the first end 106A. The gland nut 106 further includes an internal passage that extends through the first and second ends 106A, 106B of the gland nut 106 along the axis-A. The internal passage 122 of the intermediate body 104 and the internal passage of the gland nut 106 are in fluid communication with one another when the cable gland assembly 100 is assembled. The gland nut 106 is configured to snap-fit to the threaded engagement portion 120 of the intermediate body 104 to secure the cable 110 in the cable gland assembly 100. The first end 106A of the gland nut 106 includes a plurality of elongated openings 146 that extend axially from the first end 106A of the gland nut 106. The elongated openings 146 define a plurality of circumferentially spaced fingers 148 that extend axially from the second end 106B of the gland nut 106. Each of the fingers 148 include internal threads that correspond with the threads of the engagement portion 120 of the intermediate body 104. The fingers 148 are configured to elastically deform and snap fit over the threaded engagement portion 120 of the intermediate body 104. As the internal threads of the fingers 148 engage with the threaded engagement portion 120 of the intermediate body 104, the fingers 148 are pushed radially outward at the peaks of the threaded engagement portion 120 and snap back radially inward to secure the internal threads 150 in the valleys of the treaded engagement portion 120 of the intermediate body 140. The second end 106B of the gland nut 106 includes a shoulder 152. The gland nut 106 comprises or is formed from a polymeric material.

The union nut 108 includes a first end 108A, and a second end 108B opposite of the first end 108A. The union nut 108 further includes an internal passage that extends through the first and second ends 108A, 108B of the union nut 108. The first end 108A of the union nut 108 includes an opening that is sized to receive and encompass the gland nut 106 such that the gland nut 106 is disposed within the internal passage of the union nut. 108 The first end 108A of the union nut 108 further includes internal union threads 154. The internal union threads 154 are disposed along the interior surface of the union nut 108. The union nut 108 is sized such that the internal union threads 154 engage and threadedly mate to the external threads 116 of the second end 102B of the hub body 102. The second end 108B of the union nut 108 includes a shoulder 156 such that the opening at the first end 108A is wider than the opening at the second end 108B. The internal passage of the gland nut 106 and the internal passage of the union nut 108 are in fluid communication with one another when the cable gland assembly 100 is assembled. Furthermore, in the assembled configuration, the outer surface of the gland nut shoulder 152 abuts the inner surface of the union nut shoulder 156. The interfacing between the gland nut shoulder 152 and union nut shoulder 156 is configured such that when the union nut 108 is torqued on the hub body 102 the union nut shoulder 108 pushes the gland nut 106 axially along axis-A. This pushing causes the gland nut 106 to move axially along the intermediate body 104 such that the internal threads 150 of the fingers 148 push against the threaded engagement portion 120 of the intermediate body 104 whereby the fingers 148 elastically deform and snap-fit over the treaded engagement portions 120.

Once the gland nut fingers 148 engage the threaded engagement features 120 of the intermediate body 104, the gland nut 106 is configured to remain coupled to the intermediate body 104 even when the union nut 108 is uncoupled from the hub body 102. As discussed above, the intermediate body 104 secures a portion of the cable 100 in the internal passage 122 of the intermediate body 104 by compressing the cable 100 in the garter spring 134 and the bushing 140. Therefore, so long as the gland nut fingers 149 are engaged on the threaded engagement portions 120 of the intermediate body 104, then the garter spring 134 and bushing 140 remain in a compressed state such that a portion of the cable 100 is secured. This allows the union nut 108 to be uncoupled from the cable gland assembly 100 without compromising the securement of the cable 100.

After the union nut 108 is uncoupled form the hub body 102, then the intermediate body 104 can be removed from the hub body 102. Once the intermediate body 104 is removed from the hub body 102, an operator can apply the compound sealant 158 or inspect a previously applied compound sealant in the internal passage 160 at the first end 104A of the intermediate body 104. Since the intermediate body 104 is received in the hub body 103 without fasteners or threads, an operator only needs to untorque the union nut 108 to remove the intermediate body 104 to apply the compound sealant 158 or inspect previously applied sealant.

The cable gland assembly may be installed on an associated structure by following a method that includes a first step of passing the cable through the internal passages of the hub body, intermediate body, gland nut, and union nut. The method further includes a second step of coupling the hub body to the structure. The method further includes a third step of inserting the intermediate body in the internal passage of the hub body. The method further includes a fourth step of inserting the gland nut in the internal passage of the union nut such that the gland nut shoulder abuts the union nut shoulder. The method further includes a fifth step of torquing the union nut to threadedly couple the union nut to the hub body, thereby pushing the gland nut to snap-fit to the threads of the engagement portion of the intermediate body to secure the cable in the cable gland. The method further includes a sixth step of untorquing the union nut from the hub body. The method further includes a seventh step of removing the snap-fit engaged intermediate body and gland nut from the hub body, wherein the cable is secured within the intermediate body and the gland nut without the union nut. The method further includes an eighth step of applying a sealant in the internal passage of the intermediate body at the first end of the intermediate body. The method further includes a ninth step of allowing the sealant to cure. The method further includes a tenth step of reinserting the snap-fit engaged intermediate body and gland nut into the internal passage of the hub body. The method further includes an eleventh step of torquing the union nut to threadedly couple the union nut to the hub body to secure the snap-fit engaged intermediate body and gland nut in the internal passage of the hub body.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A cable gland assembly comprising:
a hub body having a first end configured to threadedly couple to a structure and a second end opposite the first end, wherein an exterior portion of the second end of the hub body is threaded, the hub body defining an internal passage;
an intermediate body with an integrated compound chamber defining an internal passage, wherein the hub body receives the intermediate body, the intermediate body having a first end and a second end opposite the first end, wherein the second end of the intermediate body includes a threaded engagement portion that extends outward past the second end of the hub body;
a gland nut having a first end and an opposite second end, the first end of the gland nut snap-fits to the threaded engagement portion of the intermediate body to secure a cable in the cable gland, the gland nut defining an internal passage such that the internal passage of the gland nut is in fluid communication with the internal passage of the intermediate body; and
a union nut having a first end and a second end opposite the first end, the first end of the union nut is threadedly coupled to the second end of the hub body, the second end of the union nut having a shoulder, the union nut defining an internal passage such that the internal passage of the union nut is in fluid communication with the internal passage of the gland nut and the internal passage of the intermediate body, wherein the gland nut fits within the internal passage of the union nut.

2. The cable gland assembly of claim 1, wherein the first end of the gland nut includes a plurality of elongated openings extending axially from the first end of the gland nut, which define a plurality of circumferentially spaced fingers, and the second end of the gland nut includes a shoulder.

3. The cable gland assembly of claim 2, wherein the circumferentially spaced fingers include internal threads that snap-fit to the threaded engagement portion of the intermediate body.

4. The cable gland assembly of claim 3, wherein the fingers elastically deform over the threaded engagement portion of the second end of the intermediate body.

5. The cable gland assembly of claim 4, wherein the shoulder of the gland nut abuts the shoulder of the union nut.

6. The cable gland assembly of claim 5, wherein torquing the union nut to the hub body causes the union nut shoulder to engage the gland nut shoulder thereby pushing the gland nut axially towards the intermediate body such that the internal threads of the fingers snap-fit over the threaded engagement portion of the intermediate body.

7. The cable gland assembly of claim 1, further comprising a bushing that is disposed within the intermediate body and disposed within the gland nut.

8. The cable gland assembly of claim 1, further comprising a washer disposed within the intermediate body.

9. The cable gland assembly of claim 1, further comprising a garter spring is disposed within the intermediate body.

10. The cable gland assembly of claim 1, wherein the intermediate body includes a compound chamber for receiving a sealing compound.

11. The cable gland assembly of claim 10, wherein the intermediate body further includes a brush-dam such that the brush-dam allows passage of the cable through the internal passage of the intermediate body while retaining the sealing compound within the compound chamber.

12. The cable gland assembly of claim 1, further comprising a flamepath disposed between the hub body and the intermediate body.

13. The cable gland assembly of claim 13, wherein the flamepath allows hot gas to dissipate out of the structure.

14. The cable gland assembly of claim 14, wherein the flamepath allows the hot gas to cool as it travels along the flamepath.

15. The cable gland assembly of claim 1, wherein the gland nut secures the cable within the internal passages of the gland nut and intermediate body when the union nut is released from the hub body.

16. A cable gland assembly comprising:
a hub body configured to receive at least a portion of a cable;
an intermediate body configured to receive at least a portion of the cable, the intermediate body having a first portion of the intermediate body that is disposed within the hub body and a second portion of the intermediate body that extends outside of the hub body, the second portion having a threaded external wall;
a gland nut configured to receive at least a portion of the cable, the gland nut having a first end and a second end, the first end having a plurality of elongated openings extending axially from the first end of the gland nut, wherein the openings define a plurality of circumferentially spaced fingers, the fingers having threaded internal walls that engage the threaded external wall of the second portion of the intermediate body, and the second end having a shoulder; and
a union nut configured to receive at least a portion of the cable, the union nut having a first end and a second end, the first end receives the gland nut and threadedly couples the union nut to the hub body, the second end having a shoulder, the union nut shoulder applies an axial force to the gland nut as the union nut is torqued onto the hub body, wherein the axial force pushes the gland nut toward the intermediate body such that the gland nut engages the threaded external wall of the second portion of the intermediate body.

17. The cable gland assembly of claim 16, wherein the gland nut is snap-fittingly engages the threaded external wall the second portion of the intermediate body.

18. The cable gland assembly of claim 16, wherein the fingers are configured to elastically deform over the threaded external wall of the second end of the intermediate body.

19. The cable gland assembly of claim 16, wherein the gland nut is comprised of a polymeric material.

20. A method of installing a cable gland assembly comprising:
providing the cable gland assembly including:
a hub body having a first end configured to threadedly couple to a structure and a second end opposite the first end, wherein an exterior portion of the second end of the hub body is threaded, the hub body defining an internal passage;
an intermediate body defining an internal passage, wherein the hub body receives the intermediate body, the intermediate body having a first end and a second end opposite the first end, wherein the second end of the intermediate body includes a threaded engagement portion that extends outward past the second end of the hub body;
a gland nut having a first end and an opposite second end, the first end of the gland nut snap-fits to the threaded engagement portion of the intermediate body to secure a cable in the cable gland, the gland nut defining an internal passage such that the internal passage of the gland nut is in fluid communication with the internal passage of the intermediate body; and
a union nut having a first end and a second end opposite the first end, the first end of the union nut is threadedly coupled to the second end of the hub body, the second end of the union nut having a shoulder, the union nut defining an internal passage such that the internal passage of the union nut is in fluid communication with the internal passage of the gland nut and the internal passage of the intermediate body, wherein the gland nut is configured to fit within the internal passage of the union nut;
passing the cable through the internal passages of the hub body, intermediate body, gland nut, and union nut;
coupling the hub body to the structure;
inserting the intermediate body in the internal passage of the hub body;
inserting the gland nut in the internal passage of the union nut such that the gland nut shoulder abuts the union nut shoulder;
torquing the union nut to threadedly couple the union nut to the hub body, thereby pushing the gland nut to snap-fit to the threads of the engagement portion of the intermediate body to secure the cable in the cable gland;
untorquing the union nut from the hub body;
removing the snap-fit engaged intermediate body and gland nut from the hub body, wherein the cable is secured within the intermediate body and the gland nut without the union nut;
applying a sealant in the internal passage of the intermediate body at the first end of the intermediate body;
allowing the sealant to cure;
reinserting the snap-fit engaged intermediate body and gland nut into the internal passage of the hub body; and
torquing the union nut to threadedly couple the union nut to the hub body to secure the snap-fit engaged intermediate body and gland nut in the internal passage of the hub body.
